(19) United States
(12) Patent Application Publication
(10) Pub. No.: US 2011/0128600 A1
(43) Pub. Date: Jun. 2, 2011

(54) OPTICAL SECURITY ELEMENT

(75) Inventors: Wayne Robert Tompkin, Baden (CH); Andreas Schilling, Hagendorn (ZG) (CH)

(73) Assignee: OVD KINEGRAM AG, Zug (CH)

(21) Appl. No.: 12/993,360

(22) PCT Filed: May 16, 2009
(86) PCT No.: PCT/EP09/03501

§ 371 Date: Feb. 2, 2011

(30) Foreign Application Priority Data
May 19, 2008 (DE) 102008024147.4-45

(51) Int. Cl. G02B 5/18; G03H 1/00; B41M 3/14

(52) U.S. Cl. 359/2; 359/576; 359/572; 427/7

(57) ABSTRACT

The invention concerns an optical security element and a process for the production of an optical security element in the form of a multilayer body having a projection element (8) in a first region of the security element for converting light transmitted through the optical security element in the first region by means of diffraction. The projection element (8) has a plurality of first zones (85) in which a first surface of a replication layer (82) has a first surface structure and an opaque metallic layer (85) is arranged on the first surface of the replication layer (82). It further has a plurality of transparent second zones (86) in which the first surface of the replication layer has a second surface structure (87) with an aspect ratio differing from the aspect ratio of the first surface structure and no opaque metallic layer is provided. The first zones (85) each have a smallest dimension of less than 20 μm and the pattern formed from the first and second zones forms a diffractive optical system which diffracts the light transmitted through the second zones (86) to represent a first item of information.

The invention concerns an optical security element in the form of a multilayer body having a projection element arranged in a first region of the security element, and a process for the production of such a security element.

Security elements which exhibit optical effects in a transmission mode are used for authentification and verification of security documents, for example banknotes.

Thus for example WO 99/37488 describes a security document and a verification method in which a projection element is provided in a transparent region of a security document. The projection element converts a light beam which, from a light source, passes through the projection element, into a light beam which shows a graphic representation in a projection plane. The security document further has an opaque region which, when the security document is appropriately folded, serves as a projection surface for the light beam converted by the projection element. To verify the security document the security document is folded and a light source is positioned on the side of the projection element opposite the projection surface so that the light beam generated by the light source passes through the projection element and generates on the projection surface a visually recognisable item of information serving as a security feature for identification of the security document. In that case the projection element comprises a diffractive relief structure which converts the transmitted light by means of diffraction to represent the projection image.

Such diffractive relief structures acting in a transmission mode usually act in relation to air or are coated with a highly refractive dielectric material.

Now the object of the invention is to provide an improved optical security element.

That object is attained by an optical security element in the form of a multilayer body having a projection element in a first region of the security element for converting light transmitted through the optical security element in the first region by means of diffraction, in which the projection element has a plurality of first zones in which a first surface of a replication layer has a first surface structure and an opaque metallic layer is arranged on the first surface of the replication layer and has a plurality of transparent second zones in which the first surface of the replication layer has a second surface structure with an aspect ratio differing from the aspect ratio of the first surface structure and there is no opaque metallic layer, wherein the first zones each have a smallest dimension of less than 20 μm and the pattern formed from the first and second zones forms a diffractive optical system which diffracts the light transmitted through the second zones to represent a first item of information.

That object is further attained by a process for the production of an optical security element in the form of a multilayer body having a projection element in a first region of the security element for converting light transmitted through the optical security element in the first region by means of diffraction, in which a surface structure is shaped into a first surface of a replication layer of the optical security element and then the first surface is partially metallised in such a way that the first region has a plurality of first zones in which the first surface of the replication layer has a first surface structure and an optical metallic layer is arranged on the first surface of the replication layer and has a plurality of transparent second zones in which the first surface of the replication layer has a second surface structure with an aspect ratio differing from the aspect ratio of the first surface structure and there is no opaque metallic layer, wherein the first zones have a smallest dimension of less than 20 μm and the pattern formed from the first and second zones forms a diffractive optical system which diffracts the light transmitted through the second zones to represent a first item of information.

The diffraction characteristics of the projection element are thus determined by a pattern of microscopically fine transparent and opaque zones, wherein a surface structure is shaped into a replication layer in the transparent zones, the aspect ratio of the surface structure differing from that in the opaque zones. Preferably in that case the pattern of opaque and transparent microscopically fine regions is generated controlled by the arrangement of the surface structures with differing aspect ratio, whereby extremely high resolution of the pattern of opaque and transparent regions can be achieved and it is guaranteed that the transparent regions coincide in coincident relationship with the surface structures with differing, preferably higher aspect ratio. In that case the pattern formed from the first and second zones provides a diffractive optical system so that the first item of information generated by diffraction of the light transmitted through the second zones differs completely from the item of information which is afforded by the arrangement of the first and second zones and is visible in reflection. It has surprisingly been found that such an arrangement admittedly provides that on the one hand the light intensity of the image generated by the projection element falls, but on the other hand a particularly high-contrast image is generated so that visual recognisability is improved. In addition the security element according to the invention is distinguished in comparison with the known security elements by improved resistance to environmental influences and by better protection from attempts at copying.

Advantageous developments of the invention are recited in the appendant claims.

In a preferred embodiment of the invention adjacent first zones, that is to say first zones which are arranged in succession and separated by a second zone, are spaced from each other at less than 20 μm, preferably less than 5 μm. That provides for an improvement in contour sharpness of the image generated by the projection element which represents the first item of information. In addition that increases the angle through which an incident light beam can be deflected by the projection element. Preferably each of the first and/or second zones further has a smallest dimension of less than 5 μm. That achieves a further improvement in the contour sharpness of the representation generated by the projection element. Preferably each of the first and/or second zones has dimensions of less than 20 μm, preferably less than 5 and first and/or second zones are thus for example formed by square zones, for example of a dimension of 10×10 μm. That also affords an improvement in contour sharpness of the representation generated by the projection element, in particular averaged over all spatial directions.

The first item of information is generated by diffraction of the light transmitted through the second zones. The first item of information thus differs from the item of information formed by the pattern of the first and second zones. When the optical security element is thus viewed in the incident light mode, for example against a background in which the first zones appear lighter than the second zones, the resulting pattern of first and second zones, which becomes visible for example upon viewing by means of a microscope, thus differs from the first item of information. That is to be attributed to the fact that the dimension and position of the first and/or second zones determine diffraction of the transmitted light when viewing in the transillumination mode and thus determine the (wavelength-dependent) deflection of the transmitted light beam, in contrast to the reflective situation where the dimension and position of the first and second zones determine the degree of brightness in the respective region of the pattern. The aspect ratio of the second surface structure is preferably greater than that of the first surface structure. Such an arrangement improves the light intensity of the image generated by the projection element.

The aspect ratio of the first and second surface structures preferably differs by more than 0.5, preferably by more than 1. In that respect as described hereinafter the first surface structure can involve a diffractive relief structure. It is however also possible for the first surface structure to involve a flat surface. The second surface structure preferably has an aspect ratio of >0.5, preferably >1, and thus differs markedly from usual relief structures which have an optical-diffraction action, and a mirror. Such a choice of the aspect ratio of the second surface structure further improves the contrast of the representation generated by the projection element.

In a preferred embodiment of the invention the arrangement and shaping of the first and second zones in the plane defined by the replication layer is so selected that the pattern of first and second zones corresponds to the imaging of a diffractive relief structure generating the first item of information, on to the pattern of first and second zones, by means of a transformation function. That transformation function associates a first predefined range of values of the profile depth of the diffractive relief structure with the first zones and a second predefined range of values of the profile depth of the diffractive relief structure with the second zones. Preferably in that respect the transformation function associates a profile depth which is less than or equal to a predefined limit value with first zones and a profile depth which is greater than the predefined limit value with second zones. The diffractive relief structure imaged by means of the above-described imaging procedure on to the pattern of first and second zones preferably involves a phase hologram of a two- or three-dimensional object, a kinoform, a computer-generated hologram, a diffractive lens or a diffractive relief structure having a plurality of mutually juxtaposed diffraction gratings with a spatial frequency of between 25 and 1000 lines/mm which differ in azimuth angle or spatial frequency.

In that respect the pattern of first and second zones is preferably determined as described hereinafter: a data set is generated, which describes the relief structure of a diffractive structure generating the first item of information in a region corresponding to the first region (in size and shaping). The region is broken down into a plurality of subregions of dimensions <20 μm, preferably <10 μm. The relief depth of each subregion, defined by the data set, is compared to a threshold value and there is associated with the respective subregion a second zone when the threshold value is exceeded and a first zone when the relief depth corresponds to or is less than the threshold value. By means of those associations the pattern of the first and second zones is then established and a corresponding surface relief is shaped into the replication layer, which has the first surface structure in the first zones and the second surface structure in the second zones. The regions are then metallised controlled by the pattern of first and second surface structures so that there is an opaque metal layer only in the region of the first zones in which the first surface structure is shaped and the regions of the second zones are not provided with an opaque metal layer.

In that case the data set can be generated either by suitable scanning of a holographically generated relief structure or it can also be calculated by means of numerical methods. Thus it is possible for example to calculate the data set in the above-described manner by means of a Fourier transformation of an object to be represented. In order in that case to achieve particularly good optical image quality of the representation generated by the projection element the following procedure has proven its worth: preferably a symmetrical object is selected as the object or a selected object is symmetrised and then the Fourier transform of the symmetrical or symmetrised object is calculated. In that case a constant is added so that the resulting function becomes real and positive. Admittedly the image impression is altered by the addition of the constant (an additional light cone appears), but in total the quality of reproduction of the representation is improved. In addition it has also proven its worth for an additional item of random phase information to be introduced prior to calculation of the Fourier transform and thus to further improve the quality of the representation generated by the projection element.

In addition it is also possible to calculate the pattern comprising the first and second zones by means of a non-linear optimisation algorithm (for example simulated annealing or genetic algorithms), in which the basic starting point adopted is a random pattern of first and second zones, the projected image is calculated by means of Fourier transformation and is then optimised from zone to zone (zone-wise) until a global optimum is found for representation of the object to be represented, that is to say the first item of information.

It has further proven desirable, when establishing the pattern comprising first and second zones, to arrange the first and second zones in a regular two-dimensional grid raster with raster widths of less than 10 μm, wherein each raster element is formed either by a first zone or a second zone. Establishing whether the respective raster element is formed in that case by a first zone or a second zone is in that respect preferably effected in accordance with one of the above-described processes.

In a preferred embodiment of the invention the pattern consisting of first and second zones is selected that an image which can be visually recognised in a projection plane is generated as the first item of information only upon illumination with collimated light. In that way it is possible to provide a concealed security feature in the optical security element, which can be rendered visible to a human viewer only by means of an auxiliary means or in given viewing situations (for example a point light source at a given spacing from the projection element), for example by means of a laser pointer. For that purpose the starting relief structure from which the pattern of first and second zones is determined as described above is a kinoform or a hologram which exhibits suitable sensitivity in respect of the angle of incidence of the light or the wavelength of the light in the first regions, for example by applying rigorous calculation methods (the Fourier transformation calculation is generally based on the thin-element approximation where there is no dependency on the angle of incidence or the wavelength, apart from the trivial dependencies). In addition a conventional hologram, the diffraction structure of which provides for differing diffraction of an incident light beam in dependence on the wavelength and the angle of incidence can be so optimised by means of the implementation of tests that under diffuse lighting conditions the first item of information no longer becomes visible to the human viewer.

In addition it is also possible for the first region to be made up from a plurality of similar subregions which are respectively subdivided into N image regions of dimensions of between 200 μm and 300 μm (N≧2). Provided in each of the N image regions of a subregion is a periodic pattern of first and second zones which diffracts the incident light in an associated angular position from the zero diffraction order. In that case the image regions of the subregion are underlaid with differing periodic patterns so that a first item of information, for example a representation of a letter that is composed of dots is generated by the image regions of a subregion. When a first region of such a configuration is irradiated with collimated light the first item of information is visually represented in a projection plane. When the first region is illuminated with diffuse, non-collimated light the angular position of the light issuing from the projection element is additionally superposed with a noise which prevents visual recognisability of the image in a projection plane.

In a preferred embodiment of the invention the first surface structure is a diffractive surface structure for representing a second item of information in reflection. In the first region therefore the security element in reflection shows the first item of information generated by the first surface structure while when viewing in transillumination mode in the projection plane (under some circumstances with the additional use of an auxiliary means), it presents the first item of information generated in optical-diffraction fashion by the pattern of first and second zones. The first and second items of information can in that case be encoded independently of each other and preferably represent different items of information. In that case the two items of information are generated in the same region by differing effects and a change in a region of the first region thus directly influences both items of information so that a subsequent change in the one item of information directly influences the other item of information and thus attempts at manipulation can be immediately detected. That configuration of the security element thus ensures a particularly high degree of safeguard against forgery.

Furthermore the security element preferably has one or more opaque second regions which preferably adjoin the first regions. In a further preferred embodiment of the invention there is also provided in the one or more second regions of the security element a metallic layer in which a diffractive relief structure is shaped to represent a third item of information in a reflection mode.

Preferably the first, second and/or third items of information form submotifs of a common motif so that for example a holographic representation extends over first and second regions and when viewed from the front side and/or the rear side the first region in which the first item of information is additionally encoded does not differ optically from the adjoining second region. That too further improves the safeguard against forgery of the security element as manipulation of the item of information which can be recognised in the reflection mode and which is generated in optical-diffraction fashion in the first region can be better recognised by the human viewer and the boundaries between the first and second regions are optically neutralised for the human viewer.

In a further preferred embodiment of the invention the security element has one or more transparent third regions which are enclosed by the first region and which are shaped in pattern form to represent a fourth item of information in the transillumination mode. Thus in the first regions, with normal viewing, in the transillumination mode, the security element has a semi-transparent appearance which is interrupted by the transparent appearance of the third regions so that when viewing in the transillumination mode under viewing conditions under which the first item of information is not visible, only the fourth item of information can be recognised by virtue of the differences in opacity of the first and third regions. Under special viewing conditions, for example when viewing in the projection plane of the projection element and upon irradiation with collimated light the first item of information then becomes visible.

Preferably the optical security element has a carrier substrate which is transparent in the region of the projection element or has a window-shaped opening in the region of the projection element. In addition it is also possible for the optical security element to have two carrier substrates, between which the projection element is arranged in a region in which the carrier substrates each have a window-shaped opening. The window-shaped opening in the carrier substrate can further be covered by a transparent film element on the side of the carrier substrate, opposite to the projection element, in order in that way to seal the window-shaped opening. The carrier substrate can thus for example comprise a plastic film over the full surface area or a paper substrate having a window-shaped opening in the region of the projection element. In that respect the optical security element may be a security document, for example a banknote or an identification document, a lamination film or a transfer film, in particular a hot embossing film.

The invention is described in greater detail hereinafter by means of a number of embodiments with reference to the accompanying drawings.

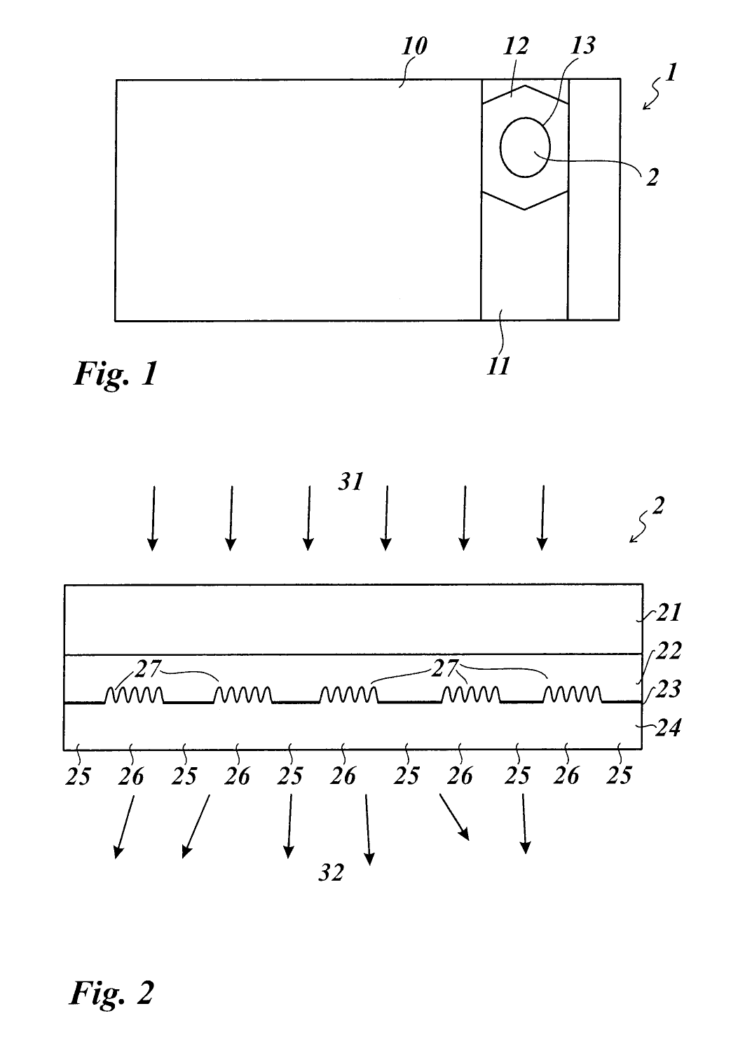

FIG. 1 shows a diagrammatic view of a security element according to the invention,

FIG. 2 shows a diagrammatic sectional view which is not true to scale of a portion of the security element of FIG. 1,

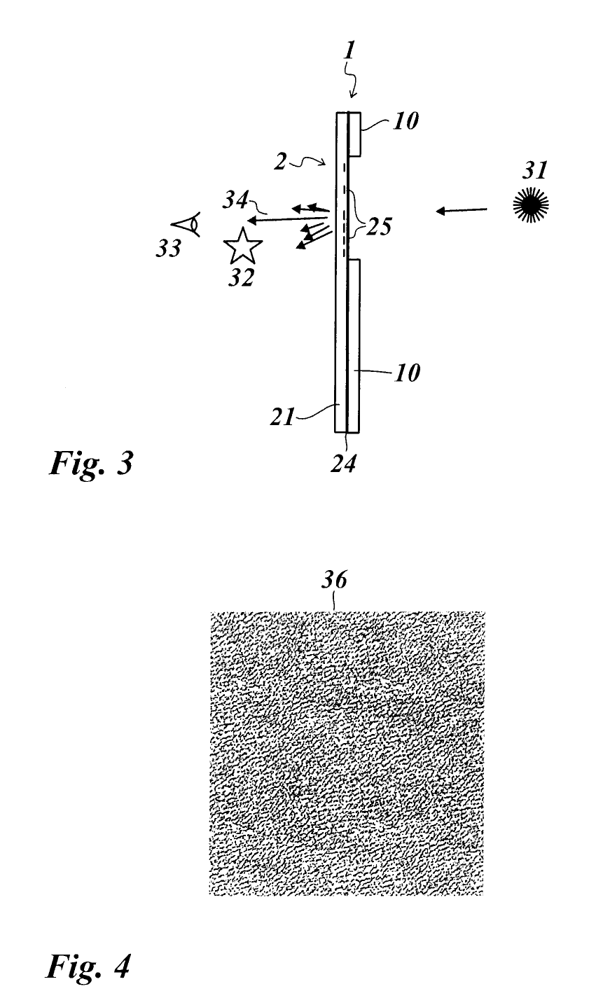

FIG. 3 shows a functional view in a first viewing situation of a security element,

FIG. 4 shows a plan view on an enlarged scale of a projection element of a security element according to the invention,

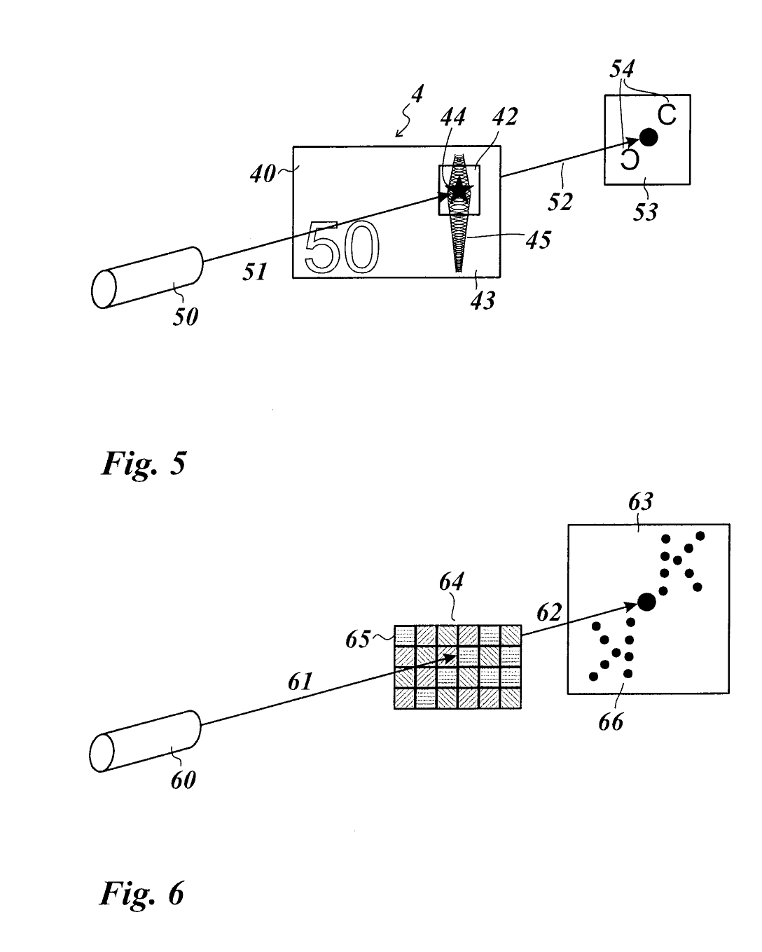

FIG. 5 shows a functional view of a further viewing situation of a security element,

FIG. 6 shows a functional view of a further viewing situation of a security element,

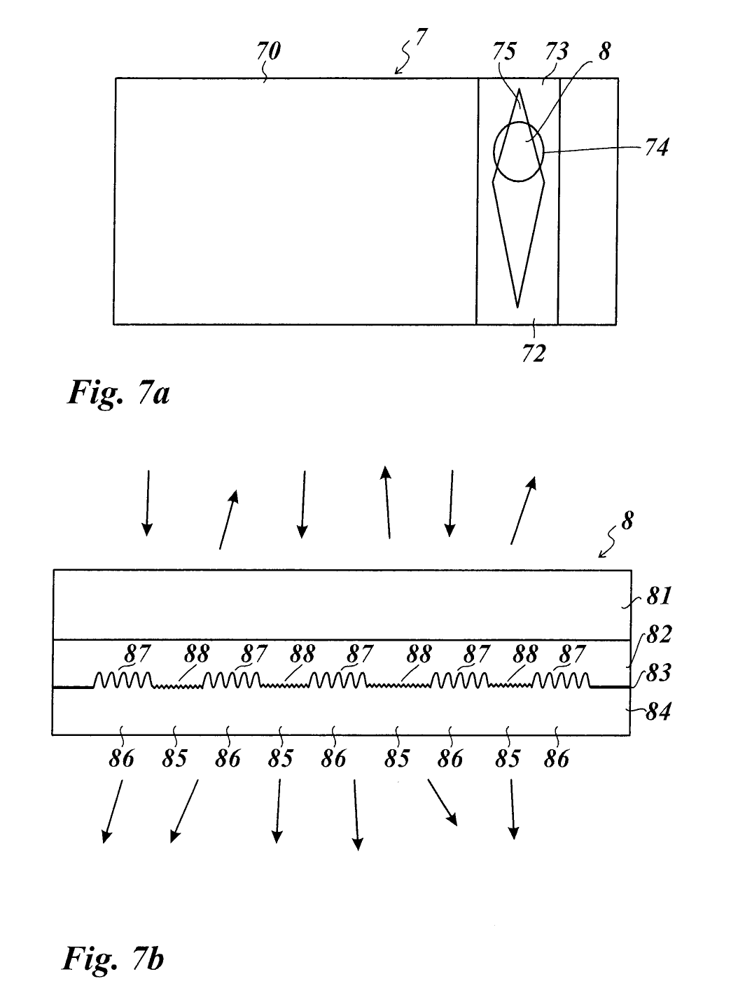

FIG. 7a shows a diagrammatic view of a security element according to the invention for a further embodiment of the invention,

FIG. 7b shows a diagrammatic sectional view which is not true to scale of a portion of the security element of FIG. 7a, and

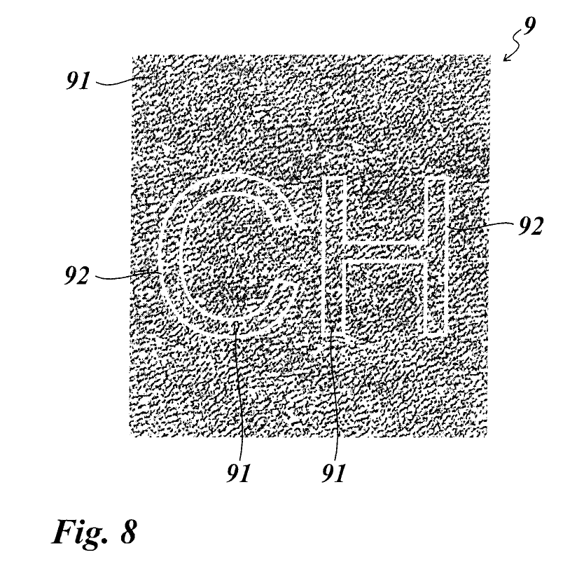

FIG. 8 shows a plan view on an enlarged scale of a portion of a projection element for a security element according to the invention.

FIG. 1 shows an optical security element 1 which is a banknote. It is further also possible for the optical security element 1 to be an identification document, for example an identity card or a passport, a money substitute, for example a cheque or a credit card, a visa, a software certificate or a label or a tag for authentication of the genuineness of goods.

The security element 1 has a carrier substrate 10 and a film element 11 applied to the carrier substrate 10. The carrier substrate 10 is preferably a paper substrate which is optionally provided with printing on the front and rear side. In addition it is also possible for the carrier substrate 10 to be a plastic substrate or to be in the form of a multilayer substrate comprising one or more plastic and/or paper layers. The film element 11 has a region 13 in which the film element 11 provides a projection element 2. A region 12 optionally adjoins the region 13, a further security feature being generated in the region 12 by the film element 11.

The film element 11 is preferably a lamination film which is shaped in strip form and which is applied over the width of the carrier substrate, as shown in FIG. 1. If the carrier substrate 10 does not comprise a transparent material, being formed for example by one or more paper layers, then the carrier substrate 10 has a window-shaped opening in the region 13. In that case it is also possible for the window-shaped opening and the region 13 in which the projection element 2 is formed not to coincide. Thus it is possible for example for the window-shaped opening to be larger than the region 13. In addition it is also possible for the region in which the film element 11 is provided with a demetallisation pattern as set forth in hereinafter to project beyond the region of the window-shaped opening.

It is possible to dispense with such a window-shaped opening in the carrier substrate 10 if the carrier substrate 10 comprises a transparent material, for example a transparent plastic film. If the carrier substrate is a multilayer substrate comprising one or more transparent and opaque layers, for example a three-layer substrate comprising a central plastic film which is provided on both sides with printing thereon or a paper layer, then in the region 13 the application of the non-transparent layer or layers is dispensed with, for example an opaque printing is not applied in that region or an opening is formed in the applied paper layer. In addition it is also possible for the film element 11 to be a transfer layer portion of a transfer film, for example a hot embossing film, or for the film element 11 not to be in strip form but to be applied to the carrier substrate 10 only in the form of a patch in the region 13.

In addition it is also possible for one or more further security elements to be also applied to the carrier substrate 10, for example in the form of a security printing or in the form of film elements which are applied to the carrier substrate 10, which include diffractive structures, thin-film layer elements, cholesteric liquid crystal layers or further elements which afford an optically variable impression. In addition it is also possible for the film element 11 to be bridged over in region-wise fashion, for example by means of offset printing, intaglio printing or screen printing or by means of microperforation or blind embossing prior to or after application to the carrier substrate 10.

The projection element 2 has a carrier film 21, a replication layer 22, a partial metal layer 23 and an adhesive and/or protective lacquer layer 24, as shown in FIG. 2.

The carrier film 21 is a plastic film of a thickness of between 12 and 120 μm, preferably a thickness of between 16 and 50 μm. In this case the plastic film preferably comprises PET, PEN or BOPP. The replication layer 22 is preferably of a thickness of between 200 nm and 5 μm and comprises a thermoplastic replication lacquer or a UV-hardenable replication lacquer. Surface structures 27 are shaped into the replication layer 22 in zones 26, the surface structures being distinguished by a high aspect ratio. The aspect ratio is the ratio of the mean depth of the relief structure to the mean spacing of the local maxima of the relief structure in the respective zone 26. If for example the surface structure 27 involves a regular surface structure with a periodic succession of similar ‘peaks’ and ‘troughs’, the profile depth represents the difference in height between a ‘peak’ and a ‘trough’ and the spacing between two adjacent ‘peaks’, that is to say the period of the regular surface structure, forms the spacing of adjacent maxima. The aspect ratio is calculated from the ratio of the profile depth to the period. Preferably the surface structure 27 has an aspect ratio of more than 0.5, further preferably more than 1 and thus markedly differs from conventional optical-diffraction relief structures which have a markedly lower aspect ratio. The surface structures 27 can in that case have a stochastic profile, for example the profile of a matt structure, or also a regular profile, for example in the form of a simple grating or a cross grating. In that case the spatial frequency of the surface structure 27 is in the range of 1000 lines/mm and 4000 lines/mm, preferably between 2500 lines/mm and 4000 lines/mm. Preferably here the local maxima of the surface structure 27 are on average spaced from each other less than the wavelength of visible light and thus form zero-order diffraction structures.

As shown in FIG. 2 the surface structure 27 is shaped into the replication layer 22 only in the zones 26 and is not shaped into the replication layer 22 in the zones 25 adjoining the zones 26. In the zones 25 the surface of the replication layer 22, that is oriented towards the metallic layer 23, has a substantially flat surface profile, that is to say the surface structure is in the form of a flat mirror surface in the zones 25. It is however also possible that a non-flat surface structure is also shaped into the replication layer 22 in the zones 25, as is further also described hereinafter with reference to FIG. 7b. The only point of significance here is that the aspect ratio of the surface structure which is shaped in the surface of the replication layer 22, that is oriented towards the metallic layer 23, is less than the aspect ratio of the surface structure 27, and differs therefrom preferably by more than 0.5, further preferably by more than 1.

Thus a pattern comprising zones 26 with surface structures 27 and zones 25 with a flat surface structure are shaped in the region 13 into the surface of the replication layer 22, that is oriented towards the metallic layer 23. If the replication layer 22 is a replication layer comprising a thermoplastic replication lacquer shaping of that pattern is effected by means of a suitably shaped embossing tool, for example an embossing punch or an embossing roller, by the application of heat and pressure. In addition it is also possible for that pattern to be shaped into the replication layer 22 by means of a UV replication process and thus for a suitable UV-hardenable replication layer to be applied to the carrier layer 21, to shape a relief structure in accordance with the pattern and in parallel therewith to harden the replication lacquer by means of UV radiation and thus to fix the shaped relief structure. In that case it is also possible to use a UV-hardenable photopolymer as the replication lacquer. The metal layer 23 is then applied to the replication layer 22. Preferably in that case the relief structure 27 is used to ensure that an opaque metal layer is provided only in the zones 25 but not in the zones 26 on the replication layer 22. Thus the metallic layer 23 is preferably applied to the replication layer 22 in a suitable layer thickness only in the zones 25 controlled by the surface structures 27 or is applied over the full surface area and is then removed again, controlled by the surface structures 27, in the regions in which the surface structure 27 is shaped, that is to say it is removed again in the zones 26. That can be effected for example by a suitable exposure procedure in a photolithographic process or an ablation procedure which utilise the different optical properties of the zones 25 and 26, caused by the surface structures 27, for partial activation of a photoresist or for partial removal of the metallic layer in the zones 26.

The layer thickness of the metal layer 23 in the zones 25 is preferably at least 10 nm, further preferably between 20 and 100 nm.

In addition it is also possible for one or more further layers to be applied to the metal layer 23, which lead to the formation of a thin-film layer element which shows the human viewer in reflection a viewing angle-dependent colour shift effect. Thus it is possible for example also to apply to the metal layer 23 a transparent spacer layer (which fulfils the λ/2, λ/4 condition for a wavelength λ in the visible spectrum of light) and for a thin absorption layer (for example a thin transparent metal layer) to be applied thereto.

The adhesive and/or protective lacquer layer 24 is then applied in a layer thickness of 500 nm to 100 μm. It would also be possible to dispense with that layer. In addition it is also possible for the projection element 2 to also have one or more further transparent layers.

The zones 25 and/or the zones 26 each have a smallest dimension of less than 20 μm and the pattern formed by the opaque zones 25 and transparent zones 26 is so selected that it forms a diffractive optical system which diffracts the light transmitted through the second zones to represent a first item of information. For that purpose the arrangement and shaping of the zones 25 and 26 in the plane defined by the replication layer and therewith the arrangement and shaping of the regions in which the surface structure 27 is shaped in the replication layer are so selected that the pattern comprising zones 25 and 26 corresponds to imaging of a diffractive relief structure generating the first item of information, on to the pattern, by means of a transformation function. For that purpose preferably a relief structure suited to the first item of information to be represented is ascertained therefrom by mathematical or holographic methods and that relief structure is then imaged on to a pattern of opaque and transparent zones by means of the transformation function.

For example in the case of a simple computer-generated hologram the procedure involved is as follows:

The Fourier transform of the object to be reconstructed is used here as the basic starting point for the calculation. When a hologram is placed in front of a lens and illuminated with coherent light the Fraunhofer diffraction pattern which appears in the focal plane of the lens represents the Fourier transform of the transmission function of the hologram and thus reconstructs the object. The Fourier transform of the object in the general case represents a complex value and thus modifies both the amplitude and the phase of the transmitted light. In order now to simulate the Fourier transform by a binary pattern of opaque and transparent zones, the following procedure is adopted: the complex transmission function of a hologram can be described by the following equation:

$$A ( {r}^{′} ) = {\sum }_{j}^{ } a ( {r}_{j} ) exp [ \frac{2 π {r}^{′} \cdot {r}_{j}}{f λ} + {iφ}_{j} ]$$

wherein f denotes the focal length of the Fourier transformation lens, λ denotes the exposure wavelength, a(rⱼ) denotes the amplitude and φⱼ denotes the phase in a subregion defined by the position rⱼ. Preferably in that case the region 13 in which the projection element 2 is provided is subdivided into a plurality of subregions of dimensions <10 μm which are arranged in a regular two-dimensional grid raster and which serve as a basis for calculations of the pattern of zones 25 and 26. Each of those subregions is referenced by its position rⱼ.

As the transmission function A(r′) is a complex function with a real and an imaginary part and thus cannot be readily imaged on to a pattern of opaque and transparent zones, the procedure adopted is preferably as follows: a symmetrical object is selected as the object to be represented (it is also possible to select an object formed by two identical mutually spaced subobjects as the symmetrical object), or an existing object is symmetrised. That provides that the imaginary part of the complex transmission function A(r′) is reduced and can thus be disregarded. In addition a constant is added to the function A(r′), which is so selected that the transmission function A(r′) becomes a positive function. The addition of the constant admittedly has the effect that a central illuminating light cone is added as a further image component in the reconstruction in the graphic representation generated by the transformation function. That light cone however only immaterially disturbs the image impression and on the other hand leads to a marked improvement in the contour sharpness in the reconstruction of the object by the pattern. That measure provides that the transformation function A(r′) is transformed into a function which is substantially real and positive and defines a uniform modulation depth. If the phase positions of the reconstruction of the object are not of significance, it is advantageous for the complex amplitude of the original object to be multiplied by a random phase φⱼ prior to calculation of the Fourier transform. That procedure corresponds to the arrangement of a diffuser in front of the object and has the effect of rendering the magnitude of the Fourier coefficient uniform. That can further improve the quality of the reconstructed image. As already stated hereinbefore it is particularly advantageous if the modulation depth of the transmission function A(r′) is as uniform as possible, that is to say the Fourier transform of the reconstruction is distributed as uniformly as possible over the subregions of the hologram. That is equivalent to a random selection of the phases φⱼ, that is to say the addition of random (white) noise to the reconstruction.

Thus the above-described measures provide for a transformation function which is substantially real and positive so that subsequently the imaginary part of the function can be disregarded and the transformation function can be described by the following equation:

$$A ( {r}^{′} ) = {\sum }_{j}^{ } {a}_{j} cos [ \frac{2 π {r}^{′} \cdot {r}_{j}}{f λ} + {φ}_{j} ]$$

wherein rⱼ represents the position of the j^{-th} pixel of the object and r′ represents the position of the corresponding subregion of the hologram, f represents the focal length of the lens, λ represents the wavelength of the recording light and φⱼ represents the random phase which is possibly added.

In addition it is advantageous for the object to be represented to be so positioned that it is between the optical axis and fλ/4d, wherein d is the raster width of the raster to which the subregions are oriented. That also provides for an improvement in reconstruction of the object. In addition a limit value t is then established and a zone 25 is associated with a subregion if at the position of the subregion r′A(r′)<t and a zone 26 is associated with the subregion, if that is not the case and for the position r′A(r′)≧t. Depending on the respective association in that case two or more zones 25 or 26 can also be provided beside each other.

In addition it is also possible that, when calculating the hologram, the transmission function of the hologram is superimposed with the transmission function of a diffractive lens, with the aim of making the light cone generated by the superimpositioning with the constant and the reconstructed image visible in different planes. In addition it is also possible to dispense with the Fourier transformation lens in calculation of the hologram and thus to make the representation of the reconstructed image visible independently of the focal length of the Fourier transformation lens in a remote projection plane.

FIG. 3 now shows a diagrammatic view of a viewing situation in which the item of information encoded by the pattern of zones 25 and 26 in the projection element 2 is made visible to the human viewer. FIG. 3 shows the security element 1 with the projection element 2, the carrier substrate 10, the adhesive layer 24, the zones 25 with the opaque metallic coating and the transparent carrier film 21. The security element 1 is exposed by a preferably coherent light source 31 in the region 13 in which the projection element 2 is arranged. In addition it is also possible to use a more remotely arranged point light source as the light source 31.

The light transmitted through transparent zones 26 of the projection element 2 is diffracted by the diffractive optical system formed as described hereinbefore from the pattern of opaque and transparent zones 25 and 26 to represent the item of information encoded by the arrangement and shaping of the zones 25 and 26, as described above. Thus for example a representation of a star-shaped object 32 is generated by the light components of the incident light, which are diffracted out of the zero order. A human viewer 33 thus on the one hand perceives the light components 34 not diffracted out of the zero order for example as a light central point or a conical region and on the other hand perceives the light components diffracted out of the zero diffraction order preferably into the first diffraction order and which reconstruct the encoded item of information, for example a star or a pair of stars, as is shown in FIG. 3.

It is also possible to use as the light source 31 any light source which is placed at a greater spacing relative to the security element 1 so that the light generated by that light source and incident on the projection element 2 is incident substantially parallel in the region 13.

Instead of the above-described computer-generated holograms 2D or 3D holograms or a kinoform can also serve as a starting hologram for generation of the pattern of opaque and transparent zones 25 and 26. In this case also—as already described above—the relief structure generating those holograms is imaged by means of a transformation function on to a pattern of zones 25 and 26 by the relief structure being broken down into a plurality of microscopically fine subregions and a zone 25 or a zone 26 being associated with the subregion in dependence on the respective profile depth of the relief structure.

FIG. 4 shows a view on an enlarged scale of a pattern 36 generated in that way comprising first and second zones, wherein the light regions in FIG. 4 represent transparent zones 26 and the dark regions in FIG. 4 represent opaque zones 25. When using 2D/3D holograms and kinoforms as the starting holograms it is also advantageous to carry out the above-described measures, that is to say to make the object to be reconstructed as symmetrical as possible or to symmetrise same and to adopt the other above-described measures. When using 3D holograms or complex computer-generated holograms as the starting hologram it is possible in that respect when selecting a suitable starting hologram to generate a pattern 36 which generates two or more different images in different projection planes so that depending on the respective viewing angle a different graphic representation becomes visible to the observer 33. In addition when using kinoforms and also holograms it is possible to achieve substantial independence of the representation on the angle of incidence.

In addition it is possible to use a relief structure of a diffractive lens as the starting relief structure for the pattern of opaque and transparent zones 25 and 26. If the diffractive lens is a lens whose transmission function corresponds to that of a spherical lens that affords a pattern of concentrically arranged, alternately arranged zones 25 and 26 which are shaped in a ring form. The radius of the end points of the successive zones rₙ is determined by the equation:

rₙ=\sqrt{fnλ}

wherein f represents the focal length of the lens, n the position of the ring in the succession of rings and λ the wavelength of the illumination. In that case n is an INTEGER value and is used as an index for referencing of the ring. In that respect, for each point in one of the transparent ring-shaped zones there exists a corresponding point in each of the other transparent ring-shaped zones for which constructive interference occurs so that that pattern of zones 25 and 26 acts like a lens of a focal length f with

$$f = \frac{{b}^{2}}{λ}$$

wherein b represents the outermost diameter of the innermost disc-shaped region. In addition the transmission function of the resulting pattern of transparent and opaque regions can also be described by the following equation:

$$t ( p ) = U [ cos ( \frac{π {p}^{2}}{f λ} ) ]$$

wherein r represents the radial co-ordinate in a cylindrical co-ordinate system and U represents an imaging function, wherein U(x)=0 for the case of x<0 and U(x)=1 for all other values of x. It has been found in that respect that it is not relevant whether the central disc-shaped region is formed by a transparent zone 26 (U(x)=1) or an opaque zone 25 (U(x)=0). Thus it was surprisingly found that the location of the focal point and the brightness of the focal point are approximately equal for both variants.

The use of patterns formed from opaque and transparent zones 25 and 26, the transmission function of which has a strong dependency on the angle of incidence of the incident light or the wavelength of the light with which the projection element is irradiated is of particular advantage. Thus FIG. 5 shows a viewing situation in which a security element 4 is illuminated by means of a coherent light beam, generated by a laser 50, of a predetermined wavelength. The security element 4 is a banknote, to the carrier substrate 40 of which a film element 43 is applied as shown in FIG. 5. In a star-shaped region 44 the film element 43 forms a projection element which is constructed as described above with reference to FIGS. 2 to 4. Beneath the region 44 the carrier substrate 40 has a window-shaped opening. The region 44 is surrounded by a region 42 in which the film element 43 has an opaque reflecting metal layer. In addition the film element 43 is provided with security printing in a region 45, as shown in FIG. 5. In regard to the structure of the individual elements of the security element 4 attention is directed to the description in such respects relating to the security element 1.

The light beam 51 incident on the projection element is diffracted by the pattern of opaque and transparent zones so that the light beam 52 issuing from the rear side of the security element 4 generates an item of information 54 on a projection screen 53.

If the projection element is not irradiated with coherent or collimated light and/or the wavelength of the light used for the irradiation operation differs from the reproduction wavelength the item of information 54 is superposed by such severe noise that it is no longer visible to the human viewer.

A further method of encoding a concealed image in the projection element is described hereinafter with reference to FIG. 6:

FIG. 6 shows a laser 60, a projection element 64 and a projection screen 63. The light 61 generated by the laser 60 and radiated on to the projection element 64 is transformed by the projection element 64 and the light transmitted through the projection element 64 generates an item of information 66 on the projection screen 63. The projection element 64 has a plurality of image regions 65 of dimensions between 10 μm and 300 μm, in which a periodic pattern of zones 25 and 26 is respectively provided. In that respect in regard to the structure of the projection element 64 attention is directed to the description relating to FIGS. 1 and 2. The period of the pattern of zones 25 and 26 in the image regions 65 is in this case 1 to 20 μm in each case. A number of N image regions which are arranged in mutually adjacent relationship respectively form a subregion diffracting the incident light to represent the item of information 66. Thus each of the subregions includes for example 9 image regions, wherein each of the image regions diffracts the incident light in another direction so that the item of information 66, for example the letter K, is produced on the projection screen 63 from the nine differently positioned pixels produced in that way. A plurality of those subregions are arranged in a larger region, for example a region of dimensions of 1.2 mm×1.2 mm. If a larger number of the subregions is exposed with collimated light the item of information 66 becomes visible to the human viewer on the projection screen 63. If however exposure is effected with non-collimated light the projected pixels are distorted by the different angular position of the incident light, uniform projection of the pixels produced by the subregions is no longer achieved and the signal/noise ratio is worsened in such a way that the item of information 66 is no longer visible to the human viewer. If light with a wider wave spectrum is used a shift of the pixels produced by the subregions also occurs, which with a suitable choice of the periodic patterns (supports such ‘smearing’) can be used to such an effect that, when selecting an unsuitable light source, the signal/noise ratio is worsened in such a way that the item of information 66 is no longer visible to the human viewer.

In addition a grey scale image can also be generated by a suitable selection of the image regions as the item of information 66, by the above-described procedure, insofar as image regions associated with the pixels are appropriately modified in their extent or the number of image regions which is associated with one of the pixels is enlarged or reduced in accordance with the grey scale.

A further embodiment of the invention will now be described with reference to FIGS. 7a and 7b.

FIG. 7a shows an optical security element 7 having a carrier substrate 70, a film element 72 and a projection element 8. The projection element 8 is formed by a subregion of the film element 72 arranged in a region 74. In addition in the region 74 the carrier substrate 70 is either transparent or has a corresponding window-shaped opening so that the projection element 8 can act in the transmission mode. The film element 72 is further transparent in a region 73 and in a region 75 has an optically variable security feature which is perceptible in reflection.

The projection element 8 has a carrier film 81, a replication layer 82, a partial metal layer 83 and adhesive and/or protective lacquer layer 84. In addition a surface structure is shaped into the replication layer 82, in which case a surface structure 88 is shaped in zones 85 and a surface structure 87 is shaped in zones 86. In addition the opaque metallic layer 83 is provided in the zones 85 and no opaque metallic layer is provided in the zones 86 so that the zones 85 are opaque and the zones 86 are transparent.

In regard to the structure of the security element 7 and the projection element 8 attention is further directed to the description relating to the foil element 1 and the projection element 2 as shown in FIGS. 1 to 4. In contrast to the projection element 2, in the case of the projection element 8 a diffractively acting surface structure is shaped in all or in a part of the opaque zones, that is to say the zones 85, wherein that surface structure diffracts the incident light reflected in the zones 85 and generates a further item of information in reflection. The surface structure 88 in this case is preferably the relief structure of a 2D/3D hologram or a computer-generated hologram, for example a Trustseal®. The spatial frequency of the relief structure in this case is preferably in a range of 100 lines/mm to 3500 lines/mm. It is however also possible for the relief structure 88 to represent a zero-order diffraction structure (preferably with a low aspect ratio, that is to say a relatively flat structure) and to have a spacing of the local maxima of the relief structure, that is below the wavelength of visible light.

Preferably in this case the surface structure 88 is also shaped into the replication layer 82 in the regions of the region 75, which are not in coincident relationship with the region 74. Thus in reflection an optically variable security element can be seen in the entire region 75 and the region 74 in which the projection element 8 is arranged is thus blurred for the viewer.

A further possible way of encoding a further item of information in the region of the projection element is described by way of example with reference to FIG. 8. FIG. 8 shows a plan view of a region of a security element, wherein a projection element is formed in regions 91 and the security element is transparent or opaque respectively over the full surface area in regions 92 which are enclosed by the regions 91 of the projection element. As indicated in FIG. 8 the regions 91 are filled with a pattern of opaque and transparent zones, which acts as a diffractive optical system, as described hereinbefore with reference to FIGS. 1 to 6. In this case dark regions represent opaque zones and light regions transparent zones. When viewing in transillumination and without using a special light source the regions 91 appear to the human viewer as a semi-transparent region which has a unitary grey effect. The regions 92 are transparent, for example by no opaque metallic layer being provided in those regions. In this case the regions 95 are preferably of a smallest dimension of more than 300 μm so that they are readily visible to the human viewer. When viewing the region shown in FIG. 8 of the security element 9 in the transillumination mode therefore the regions 92 appear markedly lighter than the regions 91 which act semi-transparently so that the item of information encoded in the shaping of the regions 92, here for example the combination of letters ‘CH’, becomes visible.

1. An optical security element in the form of a multilayer body having a projection element in a first region of the security element for converting light transmitted through the optical security element in the first region by means of diffraction,
wherein the projection element has a plurality of first zones in which a first surface of a replication layer has a first surface structure and an opaque metallic layer is arranged on the first surface of the replication layer and has a plurality of transparent second zones in which the first surface of the replication layer has a second surface structure with an aspect ratio differing from the aspect ratio of the first surface structure and there is no opaque metallic layer, wherein the first zones each have a smallest dimension of less than 20 μm and the pattern formed from the first and second zones forms a diffractive optical system which diffracts the light transmitted through the second zones to represent a first item of information.

2. An optical security element according to claim 1, wherein each of the first and/or second zones has a smallest dimension of less than 5 μm.

3. An optical security element according to claim 1, wherein adjacent first zones are spaced from each other less than 20 μm.

4. An optical security element according to claim 1, wherein the aspect ratio of the second surface structure is greater than the aspect ratio of the first surface structure and the second surface structure has an aspect ratio of greater than 0.5.

5. An optical security element according to claim 1, wherein the aspect ratio of the first and second surface structures differs by more than 0.5.

6. An optical security element according to claim 1, wherein the arrangement and shaping of the first and second zones in the plane defined by the replication layer is so selected that the pattern of first and second zones corresponds to the imaging of a diffractive relief structure generating a first item of information on to the pattern of first and second zones by means of a transformation function, which associates a first predefined range of values of the profile depth of the diffractive relief structure with first zones and a second predefined range of values of the profile depth of the diffractive relief structure with second zones.

7. An optical security element according to claim 6, wherein the diffractive relief structure is a phase hologram of a two- or three-dimensional object.

8. An optical security element according to claim 6, wherein the diffractive relief structure is a kinoform.

9. An optical security element according to claim 6, wherein the diffractive relief structure is a computer-generated hologram.

10. An optical security element according to claim 6, wherein the diffractive relief structure has a plurality of mutually juxtaposed diffraction gratings with a spatial frequency of between 25 and 1000 lines/mm, which differ in azimuth angle or spatial frequency.

11. An optical security element according to claim 6, wherein the diffractive relief structure is a diffractive lens.

12. An optical security element according to claim 1, wherein the first and second zones are arranged in a regular two-dimensional raster with raster widths of less than 10 μm, wherein each raster element is formed either by a first zone or a second zone.

13. An optical security element according to claim 1, wherein the pattern of first and second zones is so selected that an image visually recognizable in a projection plane is generated as the first item of information only upon illumination with collimated light.

14. An optical security element according to claim 13, wherein the first region has a plurality of similar subregions, each of the subregions is subdivided into N image regions of dimensions between 200 μm and 300 μm and provided in each of those N image regions of a subregion is a different periodic pattern of first and second zones, which diffracts the incident light in an associated angular position out of the zero diffraction order to generate the first item of information.

15. An optical security element according to claim 14, wherein the period of the pattern is between 2 and 20 μm.

16. An optical security element according to claim 1, wherein the first surface structure is a diffractive surface structure for representing a second item of information in reflection.

17. An optical security element according to claim 1, wherein the optical security element has one or more opaque second regions.

18. An optical security element according to claim 17, wherein in the one or more second regions, the security element has a metallic layer and a diffractive surface structure which is shaped into the metallic layer and which produces a third item of information in reflection by diffraction.

19. An optical security element according to claim 16 wherein the first, second and/or third items of information represent submotifs of a common motif.

20. An optical security element according to claim 1, wherein the optical security element has one or more transparent third regions which are enclosed by the first region and which are shaped in pattern form to represent a fourth item of information in the transillumination mode.

21. An optical security element according to claim 1, wherein the optical security element has a carrier substrate which is transparent in the region of the projection element.

22. An optical security element according to claim 1, wherein the optical security element has a carrier substrate which has a window-shaped opening in the region of the projection element.

23. An optical security element according to claim 1, wherein the optical security element is a transfer film or a lamination film.

24. A process for the production of an optical security element in the form of a multilayer body having a projection element in a first region of the security element for converting light transmitted through the optical security element in the first region by means of diffraction,
wherein a surface structure is shaped into a first surface of a replication layer of the optical security element and then the first surface is partially metallised in such a way that the first region has a plurality of first zones in which the first surface of the replication layer has a first surface structure and an optical metallic layer is arranged on the first surface of the replication layer and has a plurality of transparent second zones in which the first surface of the replication layer has a second surface structure with an aspect ratio differing from the aspect ratio of the first surface structure and there is no opaque metallic layer, wherein the first zones have a smallest dimension of less than 20 μm and the pattern formed from the first and second zones forms a diffractive optical system which diffracts the light transmitted through the second zones to represent a first item of information.

25. A process according to claim 24, wherein the process further includes the steps:
producing a data set which describes the relief structure of a diffractive surface structure generating the first item of information in a region corresponding to the first region,
breaking down the region into a plurality of subregions of dimensions <10 μm,
comparing the relief depth of each subregion, defined by the data set, to a threshold value, and associating a first zone with the respective subregions when the threshold value is exceeded and a second zone when the relief depth is below the threshold value, and
establishing the pattern of first and second zones in accordance with that association.

26. A process according to claim 25, wherein production of the data set includes the steps:
selecting a symmetrical object or symmetrisation of an object,
calculating the Fourier transform of the symmetrical or symmetrised object and adding a constant to the Fourier transform of the object so that the resulting function is real and positive.

27. A process according to claim 26 wherein production of the data set further includes the step of adding a random item of phase information.
